(19) United States
(12) Patent Application Publication
(10) Pub. No.: US 2022/0174185 A1
(43) Pub. Date: Jun. 2, 2022

(54) INFORMATION PROCESSING APPARATUS, METHOD OF GENERATING, AND COMPUTER READABLE MEDIUM

(71) Applicants: Takuma TAKAMIZAWA, Kanagawa (JP); Takayuki SUGIYAMA, Kanagawa (JP)

(72) Inventors: Takuma TAKAMIZAWA, Kanagawa (JP); Takayuki SUGIYAMA, Kanagawa (JP)

(73) Assignee: Ricoh Company, Ltd., Tokyo (JP)

(21) Appl. No.: 17/533,558

(22) Filed: Nov. 23, 2021

(30) Foreign Application Priority Data
Nov. 27, 2020 (JP) 2020-197539

(51) Int. Cl. H04N 1/60; H04N 1/00

(52) U.S. Cl. CPC H04N 1/6038; G01J 3/52; H04N 1/00819

(57) ABSTRACT

An information processing apparatus is configured to generate a color chart used for calibration. The information processing apparatus includes a first determination unit and a generation unit. The first determination unit is configured to determine a type of an additional color material to be added to a fluorescent color material used to generate a fluorescent color material chart as the color chart. The generation unit is configured to generate the fluorescent color material chart in which a plurality of patches in which the additional color material of the type determined by the first determination unit is added to the fluorescent color material, are arranged in a line and at least a bar of a color of a recording medium is arranged as a separator between the plurality of patches.

### CROSS-REFERENCE TO RELATED APPLICATIONS

The present application claims priority under 35 U.S.C. § 119 to Japanese Patent Application No. 2020-197539, filed on Nov. 27, 2020. The contents of which are incorporated. herein by reference in their entirety.

### BACKGROUND OF THE INVENTION

### 1. Field of the Invention

The present invention relates to an information processing apparatus, a method of generating, and a computer-readable medium.

### 2. Description of the Related Art

In an image forming apparatus, a process of correcting tone values of image data is performed to adjust color conditions of a printed image, and a color chart is used to generate data (calibration data) that is used to perform the correction. Specifically, the color chart is printed out, and the calibration data is generated by using a color measurement value of each of patches, which is obtained by performing a reading process on a printed material of the color chart by a reading apparatus, and by using a tone value of each of the patches of the color chart.

A method of generating calibration. data by using a certain color chart (hereinafter, may be referred to as a fluorescent color material chart), in which a plurality of patches of colors using fluorescent color materials are arranged in a single line, as the color chart as described above is known. In the fluorescent color material chart as described above, for example, a bar of a white color, i.e., a bar that is formed with the same color as a recording medium without printing ink, is arranged as a bar serving as a separator between the patches, so that it is possible to recognize the separator between the patches, and accordingly, it becomes possible to perform color measurement on each of the patches and perform color measurement on the chart in units of one line. Specifically, for example, the separator the patches is determined by using a difference between a maximum value of spectral reflectance of a recording medium portion serving as the bar as the separator between the patches and maximum values of spectral reflectance of patch portions to which color materials are applied. However, if fluorescent color materials are used for the patches, the maximum values of the spectral reflectance of the patches may exceed the maximum value of the spectral reflectance of the recording medium, so that recognition of the separator between the patches may fail and a color measurement error may occur.

As a technique for using a chart including a fluorescent component as described above, a technique in which, to effectively measure a spectral radiance factor of a sample including a fluorescent component, the necessity to measure the sample by using an ultraviolet source is determined on the basis of a spectral radiance factor that is obtained when the sample is measured using a white light source, a spectral radiance factor of the white light source that is held in advance, and a spectral radiance factor of an observation light source is disclosed (for example, Japanese Unexamined Patent Application Publication No. 2013-088292).

However, in the technique described in Japanese Unexamined Patent Application Publication No. 2013-088292, when color measurement is performed, in units of one line, on a fluorescent color material chart in which a plurality of patches of colors using the fluorescent color materials as described above are arranged in a single line, it is difficult to solve a problem with failing to recognize the separator between the patches.

### SUMMARY OF THE INVENTION

According to an aspect of the present invention, an information processing apparatus is configured to generate a color chart used. for calibration. The information processing apparatus includes a first determination unit and a generation unit. The first determination unit is configured to determine a type of an additional color material to be added to a fluorescent color material used to generate a fluorescent color material chart as the color chart. The generation unit is configured to generate the fluorescent color material chart in which a plurality of patches in which the additional color material of the type determined by the first determination unit is added to the fluorescent color material, are arranged in a line and at least a bar of a color of a recording medium is arranged as a separator between the plurality of patches.

### BRIEF DESCRIPTION OF THE DRAWINGS

FIG. 1 is a diagram illustrating an example of an entire configuration of an image forming system according to an embodiment;

FIG. 2 is a diagram illustrating an example of a configuration of a fluorescent color material chart;

FIG. 3 is a diagram for explaining operation in which recognition of a separator between patches fails in color measurement on the fluorescent color material chart;

FIG. 4 is a diagram. illustrating an example of a hardware configuration of a DFE according to the embodiment;

FIG. 5 is a diagram illustrating an example of a mechanical configuration of an image forming apparatus according to the embodiment;

FIG. 6 is a diagram illustrating an example of a hardware configuration of the image forming apparatus according to the embodiment;

FIG. 7 is a diagram illustrating an example of a functional block configuration of the DFE according to the embodiment;

FIG. 8 is a diagram illustrating an example for reducing a maximum value of a patch portion of the fluorescent color material chart;

FIG. 9 is a diagram for explaining an influence of a patch on a color measurement value due to addition of an additional color material;

FIG. 10 is a diagram for explaining a method of increasing as additional color material amount; and

FIG. 11 is a flowchart illustrating an example of the flow of a process of generating calibration data by the image forming system according to the embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An embodiment has an object to provide an information processing apparatus, a method of generating, and a computer-readable medium capable of preventing a failure in recognition of a separator between patches when color measurement is performed on a fluorescent color material chart in units of one line.

Embodiments of an information processing apparatus, a method of generating, and a computer-readable medium according to the present invention will be described in detail below with reference to the drawings. The present invention is not limited by the embodiments below, and structural elements in the embodiments below include one that can easily be thought of by a person skilled in the art, one that is practically identical, and one that is within an equivalent range. In addition, within the scope not departing from the gist of the embodiments below, various omission, replacement, and modifications of the structural elements may be made.

### Entire Configuration of Image Forming System

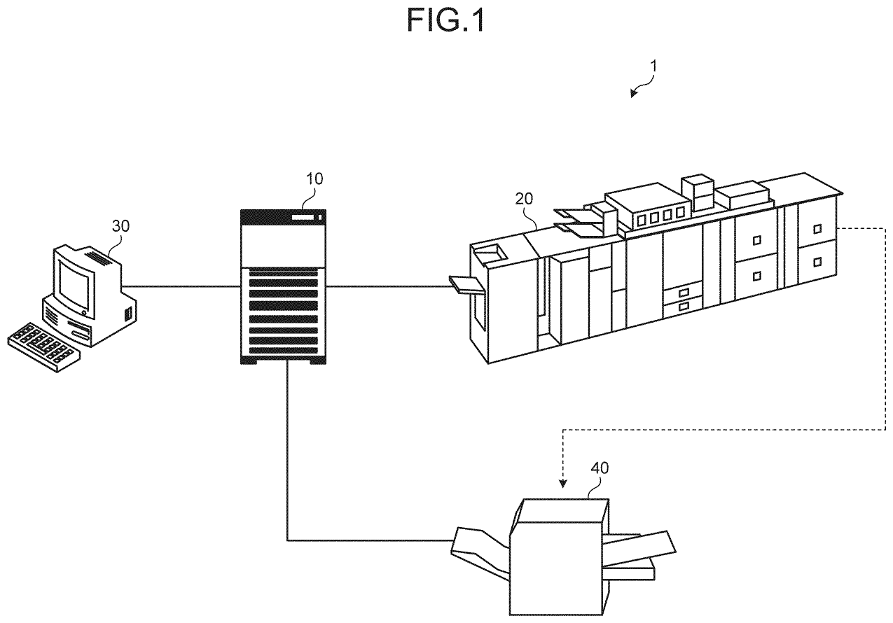

FIG. 1 is a diagram illustrating an example of an entire configuration of an image forming system according to one embodiment. With reference to FIG. 1, an entire configuration of an image forming system 1 according to the present embodiment will be described.

As illustrated in FIG. 1, the image forming system 1 includes a digital front end (DFE) 10, an image forming apparatus 20, a client personal computer (PC) 30, and a reading apparatus 40. All of the apparatuses are able to perform data communication with one another via a network, such as a local area network (LAN), a wide area network (WAN), or the Internet, that is constructed by a wired or wireless data transmission path, for example. Meanwhile, the DFE 10 and the image forming apparatus 20 may be directly connected to each other via a dedicated cable (for example, a universal serial bus (USB) cable or the like).

The DFE 10 is an information processing apparatus that communicates with the image forming apparatus 20 and controls an image forming process performed by the image forming apparatus 20. The DFE 10 converts image information that is written in a certain language, such as a page description language (PDL), into image data that is drawn in a certain format that is printable by the image forming apparatus 20. The DFE 10 transmits the converted image data to the image forming apparatus 20.

The image forming apparatus 20 is an apparatus that forms an image on a recording medium on the basis of the image data received from the DFE 10. The image forming apparatus 20 includes ejection heads, on each of which at least one of a fluorescent color material and non-fluorescent color materials (cyan (C), magenta (M), yellow (Y), black (K), etc.) is mounted, a drying mechanism for fixing the color materials, and the like. The image forming apparatus 20 is assumed. as an inkjet printer that elects ink as the color materials as described above, but is not limited thereto, and may be an electrophotographic printer that performs printing using toner. In the following description, explanation will be given based on the assumption that the image forming apparatus 20 is an inkjet printer.

Meanwhile, the DFE 10 is separated from the image forming apparatus 20, but the configurator is not limited thereto, and the functions of the DFE 10 may be included in the image forming apparatus 20, for example. Therefore, the image forming apparatus 20 having the functions of the DEE 10 may be regarded as an information processing apparatus that has the functions of the DFE 10, in addition to the DFE 10 itself.

The client PC 30 is a PC that generates image information written in a PDL or the like by an application that is installed in advance, and transmits the generated image information to the DFE 10 via a network.

The reading apparatus 40 is an apparatus that reads a color chart printed by the image forming apparatus 20, and obtains color measurement data of each of patches. The reading apparatus 40 may be a stationary reading apparatus or a handy-type reading apparatus. Further, it is assumed that the reading apparatus 40 is separated from the image forming apparatus 20, but the configuration is not limited thereto, and the reading apparatus 40 may be an in-line reading apparatus that is incorporated in the image forming apparatus 20.

### Fluorescent Color Material Chart

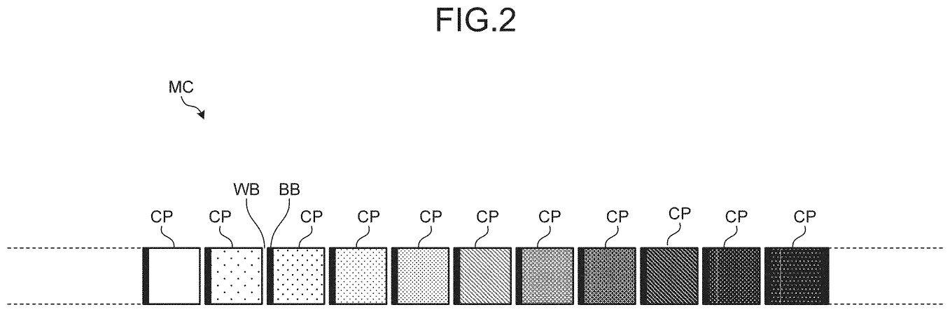

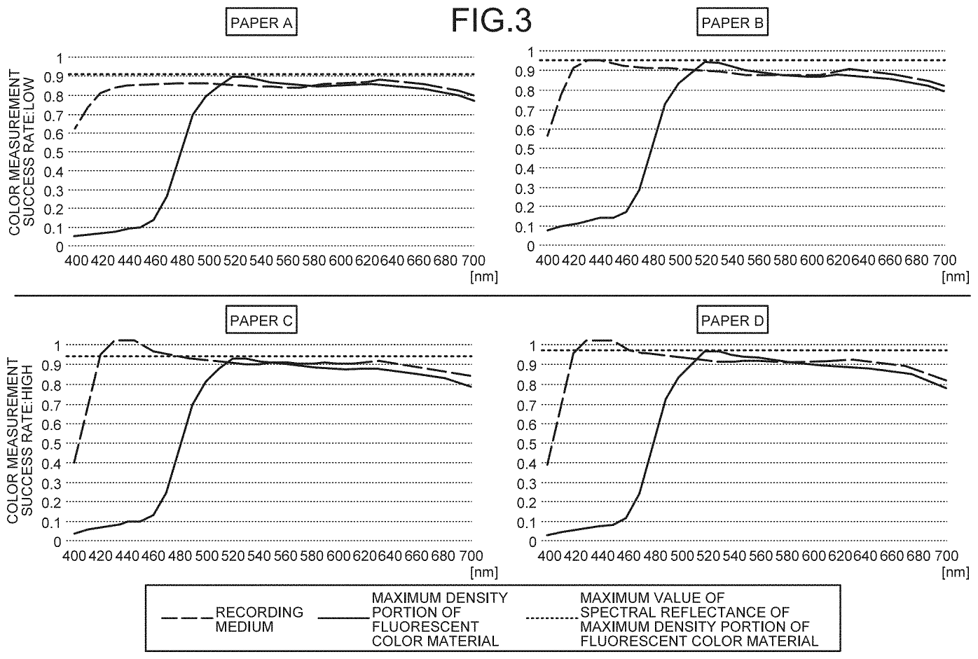

FIG. 2 is a diagram illustrating an example of a configuration of a fluorescent color material chart. FIG. 3 is a diagram for explaining operation in which recognition of a separator between the patches fails in color measurement on the fluorescent color material chart. With reference to FIG. 2 and FIG. 3, a fluorescent color material chart MC that is used by the image forming system 1 according to the present embodiment will be described.

The fluorescent color material chart MC that is used to perform calibration, which is a process for generating data (calibration data) used to correct tone values of image data, is, as illustrated in FIG. 2, a color chart in which white bars WB, i.e., bars that are formed with the same color as a recording medium without printing ink, and black bars BB are arranged as bars serving as separators between a patch CP and another patch CP. In the fluorescent color material chart MC that is printed by the client PC 30, a single line that is an array of the patches CP is collectively subjected to color measurement by the reading apparatus 40. In this case, in the fluorescent color material chart MC, the white bars WB and the black bars BB as the bars that separate the patches CP are arranged between the patches CP as described above, and it is possible to recognize the separators between the patches CP by using a difference between a maximum value of spectral reflectance of a recording medium portion of each of the white bars WB and a maximum value of spectral reflectance of each of patch CP portions to which color materials are applied. Therefore, it is possible to collectively perform color measurement on the single line that is the array of the patches CP.

The white bar WB that has the same color as the recording medium and that is arranged to recognize the separator between the patches CP as described above basically reflects a large part of light emitted from a light source, so that the maximum value of the spectral reflectance becomes larger than the maximum value of the spectral reflectance of the patch CP portion. The separator between. the patches CP is recognized by using this; however, if a fluorescent color material is used to print the patch CP portion, in some cases, a maximum value of spectral reflectance of the fluorescent color material of the patch CP portion may exceed the maximum value of the spectral reflectance of the recording medium. In this case, recognition of the separator between the patches CP fails and a color measurement error occurs. FIG. 3 illustrates a comparison between color measurement results (spectral reflectance) of the recording medium and a maximum density portion (100%) of the fluorescent color material in each of paper in which a color measurement error is likely to occur (paper A and paper B illustrated in FIG. 3) and paper in which a color measurement error is less likely to occur (paper C and paper D illustrated in FIG. 3). A horizontal axis in each of graphs represents wavelengths of emitted light, and a vertical axis represents reflectance of light at each of the wavelengths. It can be understood that, in the paper A and paper B in which a color measurement error is likely to occur, a maximum value of the spectral reflectance of the maximum density portion of the fluorescent color material is larger than a maximum value of the spectral reflectance of the recording medium.

In the present embodiment, explanation will be given of a configuration and operation for preventing a failure in recognition of the separator between the patches CP in a case in which color measurement is performed on the fluorescent color material chart in units of one line as described above.

### Hardware Configuration of DFE

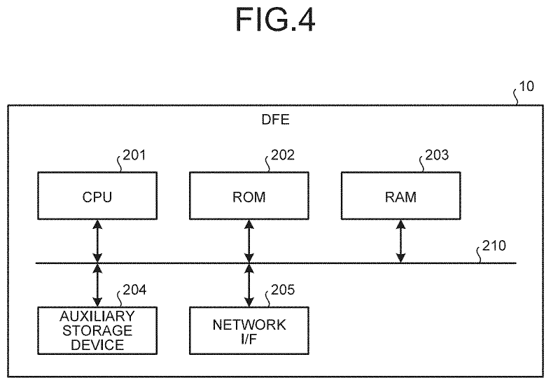

FIG. 4 is a diagram illustrating an example of a hardware configuration of the DFE according to the embodiment. The hardware configuration of the DFE 10 according to the present embodiment will be described below with reference to FIG. 4.

As illustrated in FIG. 4, the DFE 10 includes a central processing unit ((CPU) 201, a read only memory (ROM) 202, a random access memory (RAM) 203, an auxiliary storage device 204, and a network interface (I/F) 205. All of the units are communicably connected to one another via a bus 210.

The CPU 201 is an arithmetic device that controls the entire operation of the DFE 10. The CPU 201 uses the RAM 203 as a work area and executes a program stored in the ROM 202.

The auxiliary storage device 204 is a non-volatile storage device for storing image information that is received from the client PC 30 and that is written in a certain language, such as a PDL, image data that is converted in a certain format that is printable by the image forming apparatus 20, a program to be executed by the CPU 201, setting information, and various other kinds of data. The auxiliary storage device 204 is, for example, a storage device, such as a hard. disk drive (HDD), a solid state drive (SSD), a flash memory, or an optical disk, that is able to electrically, magnetically, or optically store therein information or the like.

The network I/F 205 is an interface for performing communication with external apparatuses (for example, the image forming apparatus 20, the client PC 30, the reading apparatus 40, and the like) that are connected via a network, such as a LAN, a WAN, or the Internet, that is constructed by a wired or wireless data transmission path. The network I/F 205 is, for example, an interface capable of performing communication compatible with Ethernet (registered trademark), transmission control protocol/Internet protocol (TCP/IP), or the like.

The hardware configuration of the DFE 10 illustrated in FIG. 4 is one example, and it may be possible to include structural elements other than the structural elements illustrated in FIG. 4.

### Mechanical Configuration of Image Forming Apparatus

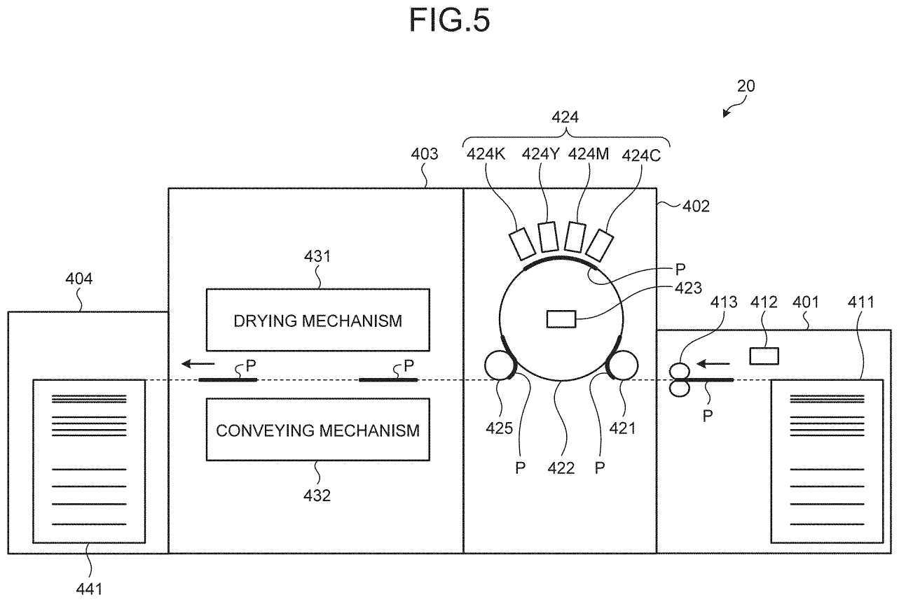

FIG. 5 is a diagram illustrating an example of a mechanical configuration of the image forming apparatus according to the embodiment. The mechanical configuration of the image forming apparatus 20 according to the present embodiment will be described with reference to FIG. 5.

As illustrated in FIG. 5, the image forming apparatus 20 mainly includes a paper feed unit 401, an image forming unit 402, a drying unit 403, and a paper election unit 404. The image forming apparatus 20 causes the image forming unit 402 to form an image with ink that is a liquid used for image formation on a recording medium P that is a sheet material fed from the paper feed unit 401, causes the drying unit 403 to dry the ink adhering to the recording medium P, and thereafter causes the paper ejection unit 404 to eject the recording medium P.

The paper feed unit 401 is a device that feeds the recording medium P to the image forming unit 402. As illustrated in FIG. 5, the paper feed. unit 401 includes a paper feed tray 411, a paper feed device 412, and a registration roller pair 413.

The paper feed tray 411 is a tray on which a plurality of sheets of the recording medium P are stacked.

The paper feed device 412 is a device that separates the sheets of recording medium P one by one and feed the recording medium P from the paper feed tray 411. Meanwhile, any paper feed device, such as a device that uses a roller or a rotating member or a device that uses air suction, may be used as the paper feed device 412.

The registration roller pair 413 is a pair of rollers for sending the recording medium P fed from the paper feed device 412 to the image forming unit 402. When a leading end of the recording medium P fed by the paper feed device 412 reaches the registration roller pair 413, the registration roller pair 413 is driven at a predetermined timing to feed the recording medium P to the image forming unit 402.

Meanwhile, the configuration of the paper feed unit 401 is not specifically limited as long as it is possible to feed the recording medium P to the image forming unit 402.

The image forming unit 402 is a device that ejects ink from an ink ejection unit to the recording medium P to perform image formation (printing) on the recording medium P. As illustrated in FIG. 5, the image forming unit 402 includes a receiving drum 421, a paper bearing drum 422, a suction device 423, an ink ejection unit 424, and a transfer drum 425.

The receiving drum 421 is a drum-shaped member that holds, by a paper gripper arranged on a surface thereof, the recording medium P fed from the paper feed unit 401, and conveys the recording medium P with surface movement. The receiving drum 421 transfers the conveyed recording medium P to the paper bearing drum 422 at a position facing the paper bearing drum 422.

The paper bearing drum 422 is a drum that holds, by a paper gripper arranged on an outer periphery thereof, the recording medium P conveyed by the receiving drum 421, and conveys the recording medium P with surface movement. A plurality of suction holes are formed in a distributed manner on the surface of the paper bearing drum 422, and suction airflows toward the inside of the paper bearing drum 422 is generated by suction operation of the suction device 423. A leading end of the recording medium P that is transferred from the receiving drum 421 to the paper bearing drum 422 is gripped by the paper gripper, and the recording medium P is adsorbed and held on the surface of the paper bearing drum 422 with the aid of the suction airflows, and conveyed with surface movement of the paper bearing drum 422.

The ink ejection unit 424 is a group of ejection heads that eject ink toward the recording medium P held on the paper bearing drum 422. The ink ejection unit 424 forms an image by electing ink of four colors of cyan (C), magenta (M), yellow (Y), and black (K). The ink election unit 424 includes an ejection head 424C that elects ink of cyan (C), an ejection head 424M that ejects ink of magenta (K), an ejection head 424Y that ejects ink of yellow (Y), and an ejection head 424K that ejects ink of black (K). Ejection operation of each of the ejection heads 424C, 424K, 424Y, and 424K is controlled by a drive signal corresponding to image data. Each of the ejection heads 424C, 424K, 424Y, and 424K ejects color ink when the recording medium P that is held on the paper bearing drum 422 passes through a region facing the ink ejection unit 424, and an image corresponding to the image data is formed. Meanwhile, the configurations of the ejection heads 424C, 424M, 424Y, and 424K are not specifically limited as long as it is possible to eject ink, and any configuration is applicable. For example, it may be possible to arrange an ejection head that ejects special ink of white, gold, silver, or the like or arrange an ejection head that ejects a liquid, such as a surface coating liquid, which is not used to form an image, as needed basis. In the present embodiment, explanation will be given based on the assumption that an ejection head capable of ejecting ink of a fluorescent color material is arranged in addition to the ejection heads 424C, 424M, 424Y, and 424K. In this case, it may be possible to arrange an ejection head that ejects ink or a fluorescent color material separately from the ejection heads 424C, 424M, 424Y, and 424K, or it may be possible to mix a fluorescent color material with ink of any of the existing ejection heads 424C, 424K, 424Y and 424K.

The transfer drum 425 is a drum-shaped member for transferring the recording medium P that is conveyed by the paper bearing drum 422 to the drying unit 403.

The drying unit 403 is a device that dries the ink that is ejected onto the recording medium P by the image forming unit 402. As illustrated in FIG. 5, the drying unit 403 includes a drying mechanism 431 and a conveying mechanism 432.

The drying mechanism 431 is a mechanism that dries the ink that is ejected onto the recording medium P by the image forming unit 402. When the recording medium P passes through the drying mechanism 431, a drying process is performed on the ink on the recording medium P, so that a liquid, such as moisture, in the ink evaporates, the ink adheres to the recording medium P, and the recording medium P is prevented from bending.

The conveying mechanism 432 is a mechanism that conveys the recording medium P, on which the ink is ejected by the image forming unit 402, such that the recording medium P is dried by the drying mechanism 431, and sends the recording medium P to the paper ejection unit 404.

The paper ejection unit 404 is a device for stacking the recording medium P on which the image is formed by the image forming unit 402 and which is subjected to the drying process by the drying unit 403. As illustrated in FIG. 5, the paper ejection unit 404 includes a paper ejection tray 441.

The paper ejection tray 441 is a tray for sequentially stacking and holding the sheets of recording medium P conveyed from the drying unit 403.

Meanwhile, the configuration of the paper ejection unit 404 is not specifically limited as long as it is possible to eject the recording medium P.

Furthermore, the image forming apparatus 20 may appropriately include a device with a different function, in addition to the components illustrated in FIG. 5. For example, it may be possible to add a pre-processing unit between the paper feed unit 401 and the image forming unit 402 to perform pre-processing for image formation, or it may be possible to add a post-processing unit between the drying unit 403 and the paper ejection unit 404 to perform post-processing for image formation. Examples of the pre-processing unit include a unit that performs a treatment liquid application process of applying a treatment liquid for preventing bleeding caused by a reaction with the ink, but details of the pre-processing are not specifically limited. Furthermore, examples of the post-processing unit include a unit that performs a paper inverting conveying process of inverting the recording medium P on which the image is formed by the image forming unit 402 and conveying the recording medium P to the image forming unit 402 again to form images on both sides of the recording medium P, a process of binding a plurality of sheets of recording medium P on which images are formed, a correction process of correcting sheet deformation, or a cooling process of cooling the recording medium P, but details of the post-processing are not specifically limited.

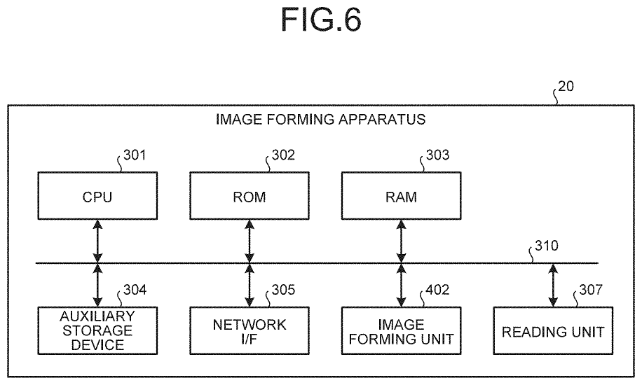

Hardware configuration of image forming apparatus FIG. 6 is a diagram illustrating an example of a hardware configuration of the image forming apparatus according to the embodiment. The hardware configuration of the image forming apparatus 20 according to the present embodiment will he described below with reference to FIG. 6.

As illustrated in FIG. 6, the DFE 10 includes a CPU 301, a ROM 302, a RAM 303, an auxiliary storage device 304, a network I/F 305, the image forming unit 402, and a reading unit 307. All of the units are communicably connected to one another via a bus 310. The configuration of the image forming unit 402 is the same as described above.

The CPU 301 is an arithmetic device that controls entire operation of the image forming apparatus 20. The CPU 301 uses the RAM 303 as a work area and executes a program stored in the ROM 302.

The auxiliary storage device 304 is a non-volatile storage device for storing the image data received from the DFE 10, a program to be executed by the CPU 301, setting information, and various other kinds of data. The auxiliary storage device 304 is, for example, a storage device, such as an HDD, an SSD, a flash memory, or an optical disk, that is able to electrically, magnetically, or optically store therein information or the like.

The network I/F 305 is an interface for performing communication with external apparatuses (for example, the DFE 10 and the like) that are connected via a network, such as a LAP, a WAN, or the Internet, that is constructed by a wired or wireless data transmission path. The network I/F 305 is, for example, an interface capable of performing communication compatible with Ethernet (registered trademark), TCP/IP, or the like.

The reading unit 307 is a device that performs a reading process on the recording medium P on which the image is formed by the image forming unit 402. The reading unit 307 may implement the functions of the reading apparatus 40 as described above.

The hardware configuration of the image forming apparatus 20 illustrated in FIG. 6 is one example, and it may be possible to include structural elements other than the structural elements illustrated in FIG. 6.

Functional block configuration and operation of DFE

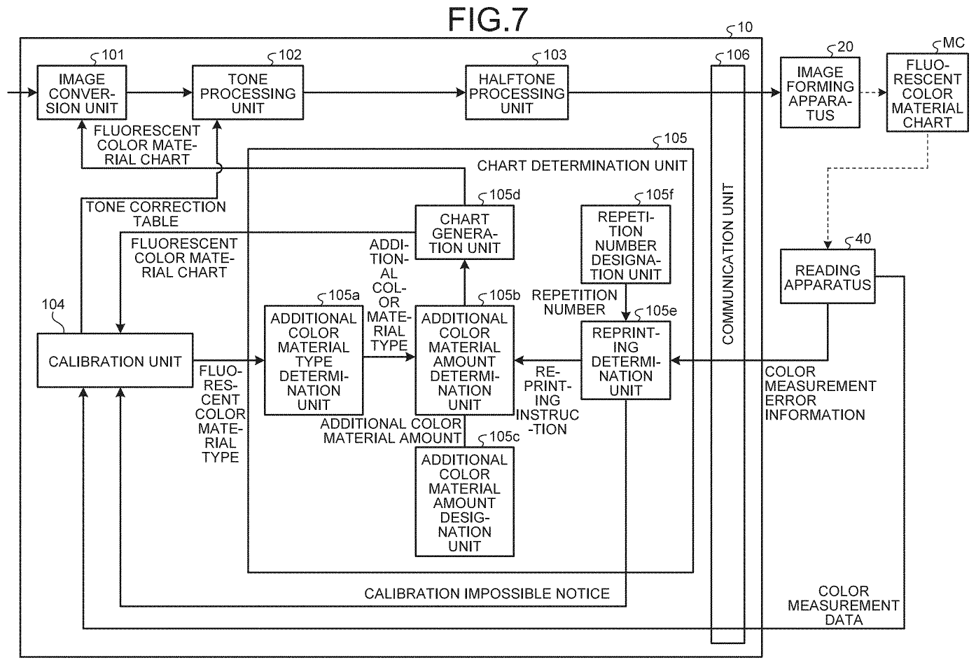

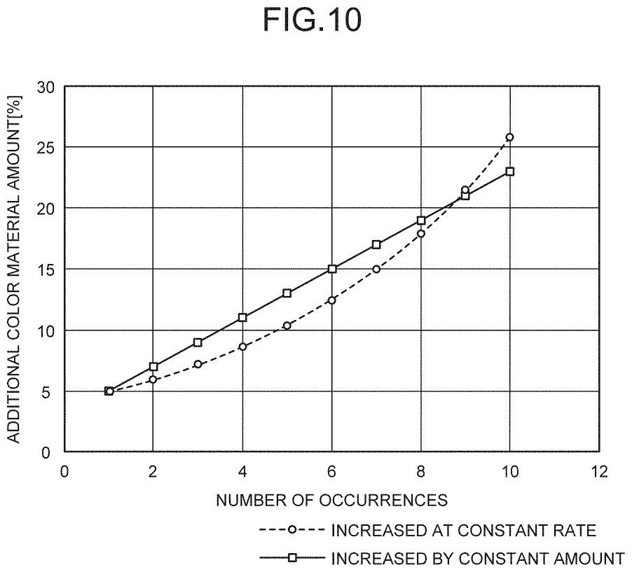

FIG. 7 is a diagram illustrating an example of a functional block configuration of the DFE according to the embodiment. FIG. 6 is a diagram illustrating an example for reducing the maximum value of the patch portion of the fluorescent color material chart. FIG. 9 is a diagram for explaining an influence of the patch on a color measurement value due to addition of an additional color material. FIG. 10 is a diagram for explaining a method of increasing an additional color material amount. The functional block configuration and the operation of the DFE 10 according to the present embodiment will be described below with reference to FIG. 7 to FIG. 10.

As illustrated in FIG. 7, the DFE 10 includes an image conversion unit 101, a tone processing unit 102, a halftone processing unit 103, a calibration unit 104, a chart determination unit 105, and a communication unit 106 (acquisition unit).

The image conversion unit 101 is a functional unit that performs an image conversion process, such as language interpretation, rasterization, or a color conversion process for conversion to process colors (for example, CMYK), on image information (electronic document) that is received from the client PC 30. Further, the image conversion unit 101 performs the same process on data of a fluorescent color material chart that is generated by a chart generation unit 105d (to be described later). The image conversion unit 101 is implemented by causing the CPU 201 illustrated in FIG. 4 to execute a program, for example.

The tone processing unit 102 is a functional unit that performs, with use of a tone correct on table that is generated through calibration performed by the calibration unit 104, a tone correction process on the image data that is subjected to the image conversion process by the image conversion unit 101, a total amount control process of controlling a total amount of a color material, and the like. The tone processing unit 102 is implemented by causing the CPU 201 illustrated in FIG. 4 to execute a program, for example.

The halftone processing unit 103 is a functional unit that converts 8-bit data for each of ink colors to a certain data format (for example, 2-bit data for each of ink colors) of the image forming apparatus 20 with respect to the image data that is subjected to the tone correction process by the tone processing unit 102. The halftone processing unit 103 transmits the converted image data to the image forming apparatus 20 via the communication unit 106. The halftone processing unit 103 is implemented by causing the CPU 201 illustrated in FIG. 4 to execute a program, for example.

The calibration unit 104 is a functional unit that, at the time of calibration using the fluorescent color material chart, generates, as calibration data, a tone correction table (one example of tone correction information) for performing tone correction on the image data by the tone processing unit 102, by using color measurement data of each of the patches read by the reading apparatus 40 from the recording medium P on which the fluorescent color material chart is printed, and by using data of the fluorescent color material chart. The calibration unit 104 is implemented by causing the CPU 201 illustrated in FIG. 4 to execute a program, for example.

The chart determination unit 105 is a functional unit that generates the fluorescent color material chart used for the calibration. As illustrated in FIG. 7, the chart determination unit 105 includes an additional color material type determination unit 105a (first determination unit), an additional color material amount determination unit 105b (second determination unit), an additional color material amount designation unit 105c, the, chart generation unit 105d (generation unit), a reprinting determination unit 105e (determination unit), and a repetition number designation unit 105f. The chart determination unit 105 is implemented by causing the CPU 201 illustrated in FIG. 4 to execute a program, for example.

The additional color material type determination unit 105a is a functional unit that, when the calibration unit 104 performs calibration, determines a type of an additional color material that is to be added to a fluorescent color material of each of the patches of the fluorescent color material chart, on the basis of a type of the fluorescent color material that is notified by the calibration unit 104. For example, it may be possible to generate a table in which the type of the fluorescent color material and the type of the additional color material are associated in advance, and the additional color material type determination unit 105a may refer to the table and identify the type of the additional color material corresponding to the type of the fluorescent color material that is notified by the calibration unit 104. With this configuration, it is possible to determine a material that is appropriate as the additional color material to be added to the fluorescent color material.

Meanwhile, it is preferable to use, as the additional color material, a material that is less likely to affect characteristics of a certain value (a density, a b* value of an L*a*b* value, or the like) that is used for the calibration among color measurement values of the fluorescent color material. This is because the additional color material is added to the fluorescent color material in order to prevent a color measurement error on the fluorescent color material chart, and it is desirable to prevent the additional color material from affecting color measurement values as much as possible. For example, it is preferable to adopt, as the additional color material, an achromatic color material because the fluorescent color material basically has a chromatic color. Examples of the achromatic color material include a black color material, a gray color material, and a white color material. Furthermore, for example, if it is assumed that a color measurement value of the fluorescent color material is a certain value for which an absolute value in the b* direction is large, it is preferable that the additional color material has a certain value in which an absolute value in the b* direction is small even if the additional color material has a certain value in the a* direction. With this configuration, it is possible to prevent an influence on the color measurement values of the fluorescent color material chart as much as possible. Furthermore, it may be possible to allow a user to designate the type of the additional color material.

In the calibration, it is common to use a density value of the color material as a characteristic value, but in the calibration on the fluorescent color material, an L*a*b* value may be used as the characteristic value in some cases. FIG. 9 illustrates a graph that represents a color measurement result of a fluorescent color material chart of fluorescent yellow (NeY). A horizontal axis of the graph represents a tone value [%] of each of the patches of the fluorescent color material chart, and a vertical axis represents a value (b* value) of a b* component (yellow component) that is used as the characteristic value in the color measurement result with respect to the patch having each of the tone values. As described above, the additional color material is added to prevent a color measurement error on the fluorescent color material chart, but if an expected value is not obtained as the color measurement value of the generated fluorescent color material chart, the color measurement becomes meaningless. In FIG. 9, a color measurement result of the fluorescent color material chart of only fluorescent yellow (NeY) is indicated by a dashed line, and a color measurement result of a fluorescent color material chart in which black ink as the additional color material is uniformly added by 5 [%] to fluorescent yellow is indicated by a solid line. As illustrated in FIG. 9, the b* value is slightly reduced due to addition of the black ink as the additional color material, but a shape of a graph of the fluorescent yellow (NeY) and a shape of a graph of the fluorescent yellow to which the additional color material (black ink) is added are substantially the same. In the calibration, if the shapes of the graphs of the color measurement values (in this example, the b* values) are the same, a slight difference in a dynamic range is less likely to affect image quality of a printing image, so that a practical problem does not occur.

The additional color material type determination unit 105a notifies the additional color material amount determination unit 105b of the determined type of the additional color material and the type of the fluorescent color material.

The additional color material amount determination unit 105b is a functional unit that determines an additional color material amount designated by the additional color material amount designation unit 105c as an amount for which the additional color material of the type notified by the additional color material type determination unit 105a is added to the fluorescent color material. The additional color material amount determination unit 105b notifies the chart generation unit 105d of the type of the fluorescent color material, the type of the additional color material, and the determined additional color material amount.

Furthermore, when a color measurement error occurs as a result of the reading process that is performed by the reading apparatus 40 on the recording medium P on which the fluorescent color material chart is printed, and if the additional color material amount determination unit 105b receives an instruction on reprinting from the reprinting determination unit 105e, the additional color material amount determination unit 105b determines, as a new additional color material amount, an amount that is obtained by increasing the additional color material amount notified to the chart generation unit 105d by a predetermined amount. Whether the color measurement on the fluorescent color material chart is successful is not determined only based on the fluorescent color material and the additional color material, but is also dependent on a type of the recording medium P. Therefore, in the image forming system 1 according to the present embodiment, to cope with various kinds of the recording medium P, if the color measurement fails, operation of re-generating a fluorescent color material chart in which the additional color material amount is increased by a predetermined amount and re-performing color measurement by using the newly generated fluorescent color material chart is performed. With this configuration, even if first color measurement has failed, it is possible to improve the probability that second and subsequent color measurement is successful.

As a method of increasing the additional color material amount, it may be possible to adopt a method of increasing the amount by a constant amount every time a color measurement error occurs or a method of increasing the amount at a constant rate. FIG. 10 illustrates a change in the additional color material amount with respect to the number of occurrences of a color measurement error. A horizontal axis of a graph represents the number of occurrences of a color measurement error, and a vertical axis represents the additional color material amount. An amount of change varies depending on an amount and a rate of increase; however, in the method of increasing the amount by a constant amount, the amount is increased by the constant amount regardless of the number of occurrences of a color measurement error, so that it is more likely that measurement becomes successful even if the number of occurrences is small. However, the additional color material amount may excessively be increased, and the additional color material may largely affect the color measurement value. In contrast, in the method of increasing the amount at a constant rate, the amount of increase is small when the number of occurrences of a color measurement error is small, and the amount of increase is increased with an increase in the number of occurrences. Therefore, it is possible to attempt the color measurement again in a range in which an influence of the additional color material on the color measurement value is small while the number of occurrences is small, and it is possible to improve the probability of success in the color measurement by increasing the amount of increase with an increase in the number of occurrences. However, if an initial additional color material amount and the additional color material amount by which a color measurement error does not occur are largely different, the number of occurrences may increase. Meanwhile, it may be possible to allow a user to designate the method and the amount of increase in the additional color material amount.

The additional color material amount designation unit 105c is a functional unit that notifies the additional color material amount determination unit 105b of the additional color material amount that is an amount of the additional color material to be added to the fluorescent color material. The additional color material amount notified by the additional color material amount designation unit 105c may be designated by a user or may be stored in advance for each of conditions, such as the type of the fluorescent color material or a paper type.

The chart generation unit 105d is a functional unit that generates the fluorescent color material chart on the basis of the type of the fluorescent color material, the type of the additional color material, and the additional color material amount notified by the additional color material amount determination unit 105b. Specifically, as illustrated in FIG. 2 as described above, the chart generation unit 105d generates the fluorescent color material chart in which at least the white bars WB, i.e., bas that are formed with the same color as the recording medium without printing ink, are arranged as the bars serving as separators between the patches CP. Meanwhile, it may be possible to arrange the black bars BB in addition to the white bars WB as the separators between the patches CP. The chart generation unit 105d sends the generated fluorescent color material chart to the image conversion unit 101 for printing out the fluorescent color material chart, and sends the generated fluorescent color material chart to the calibration unit 104 for use for the calibration. Meanwhile, the chart generation unit 105d may refer to information in which a combination of the type of the fluorescent color material, the type of the additional color material, and the additional color material amount is associated with a fluorescent color material chart and determine a fluorescent color material chart to be used on the basis of the information.

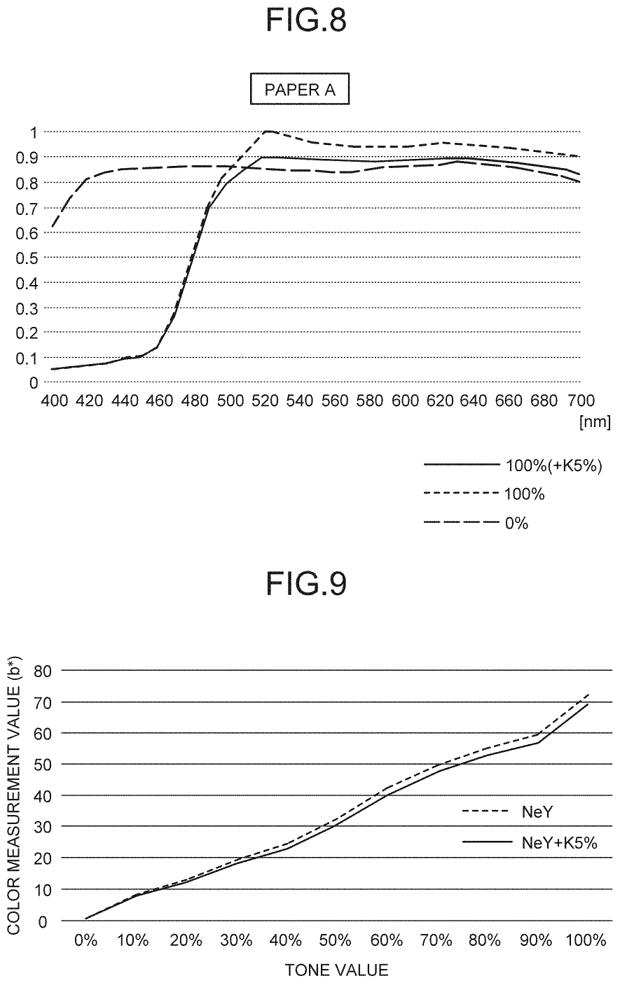

The fluorescent color material chart that is sent to the image conversion unit 101 is subjected to the processes performed by the tone processing unit 102 and the halftone processing unit 103, and printed out (image formation) by the image forming apparatus 20. Further, the reading apparatus 40 performs the reading process on the printed fluorescent color material chart. In this manner, in the fluorescent color material chart according to the present embodiment, by adding the additional color material that is different from the fluorescent color material by a certain amount (additional color material amount), it is possible to prevent the maximum value of the spectral reflectance of the patch portion of the fluorescent color material chart from exceeding the maximum value of the spectral reflectance of the recording medium P. Here, in FIG. 8, a graph of the spectral reflectance of the recording medium P is indicated by a chain line, a graph of the spectral reflectance of the patch portion of fluorescent yellow (100 [%]) is indicated by a dashed line, and a graph of the spectral reflectance of the patch portion in which the color material of K (black) is added by 5 [%] to the fluorescent yellow (100 [%]) is indicated by a solid line. As illustrated in FIG. 8, it is indicated that the maximum value of the spectral reflectance of the patch portion in which the color material of K (black) is added by 5 [%] to the fluorescent yellow (100 [%]) is prevented from exceeding the maximum value of the spectral reflectance of the recording medium P. With this configuration, when color measurement is performed on the fluorescent color material chart in units of one line, it is possible to prevent an occurrence of a color measurement error and prevent a failure in recognition of the separators between the patches.

If the reading apparatus 40 normally obtains color measurement data, the reading apparatus 40 transmits the color measurement data to the calibration unit 104 via the communication unit 106. Furthermore, if the reading apparatus 40 fails to normally obtain the color measurement data and a color measurement error occurs, the reading apparatus 40 notifies the reprinting determination unit 105e of color measurement error information via the communication unit 106.

The reprinting determination unit 105e is a functional unit that, when receiving the color measurement error information from the reading apparatus 40 via the communication unit 106, determines whether the number of occurrences of a color measurement error reaches a repetition number (predetermined number) that is designated by the repetition number designation unit 105f.

If the number of occurrences of a color measurement error reaches the repetition number, the reprinting determination unit 105e notifies the calibration unit 104 of a calibration impossible notice indicating that calibration is impossible. In this case, the calibration unit 104 terminates the calibration without generating calibration data. Meanwhile, when the calibration unit 104 receives the calibration impossible notice, it may be possible to switch to a mode in which color measurement is performed on the patches of the fluorescent color material chart one by one, instead of causing the calibration unit 104 to terminate the calibration. In this case, it takes time to perform color measurement, but a color measurement error does not occur.

In contrast, if the number of occurrences of a color measurement error does riot reach the repetition number, the reprinting determination unit 105e gives an instruction to reprint the fluorescent color material chart to the additional color material amount determination unit 105b. Upon receiving the instruction on reprinting from the reprinting determination unit 105e, the additional color material amount determination unit 105b, determines as a new additional color material amount, an amount that is obtained by increasing the additional color material amount notified to the chart generation unit 105d by a predetermined amount as described above, and notifies the chart generation unit 105d of the type of the fluorescent color material, the type of the additional color material, and the newly determined additional color material amount.

The repetition number designation unit 105f is a functional unit that notifies the reprinting determination unit 105e of the repetition number. The repetition number notified by the repetition number designation unit 105f may be designated by a user or may be determined in advance as default.

The communication unit 106 is a functional unit that performs data communication with external apparatuses (the image forming apparatus 20, the client PC 30, the reading apparatus 40, and the like) other than the DFE 10. The communication unit 106 is implemented by the network I/F 205 illustrated in FIG. 4 and by causing the CPU 201 illustrated in FIG. 4 to execute a program, for example.

Meanwhile, a part or all of the image conversion unit 101, the tone processing unit 102, the halftone processing unit 103, the calibration unit 104, and the chart determination unit 105 as described above may be implemented by an integrated circuit, such as a field-programmable gate array (FPGA) or an application specific integrated circuit (ASIC), instead of a software program.

Furthermore, each of the functional units of the DFE 10 illustrated in FIG. 7 are functionally conceptual and do not necessarily have to be configured in the manner as illustrated in the drawings. For example, a plurality of functional units that are illustrated as independent functional units of the DFE 10 in FIG. 7 may be configured as a single functional unit. In contrast, a single functional unit of the DFE 10 illustrated in FIG. 7 may be divided into a plurality of units, and may be configured as a plurality of functional units.

Flow of process of generating calibration data

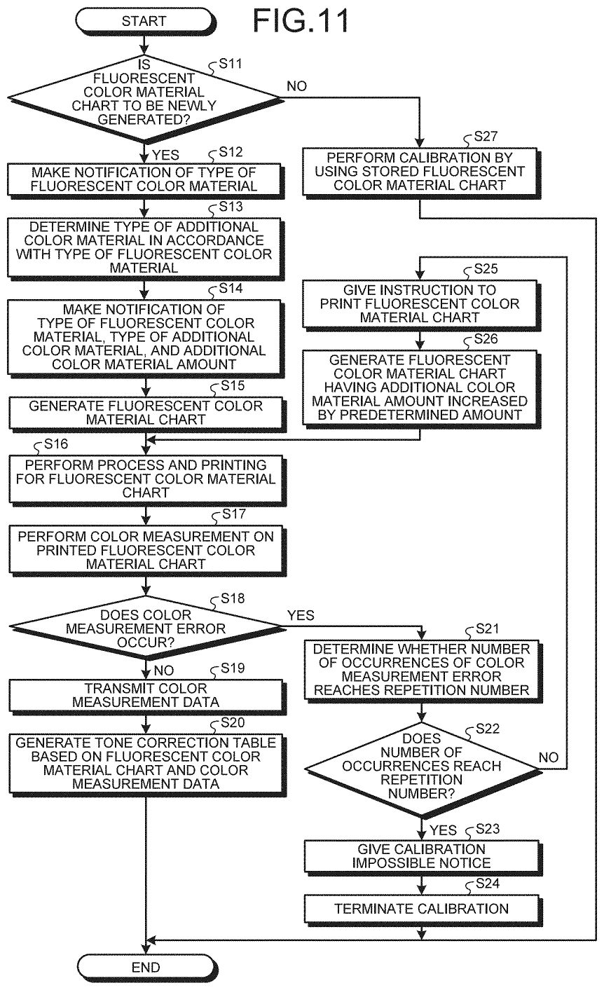

FIG. 11 is a flowchart illustrating an example of the flow of generating calibration data by the image forming system according to the embodiment. With reference to FIG. 11, the flow of the process of generating calibration data by the image forming system 1 will be described.

The process of generating calibration data illustrated in FIG. 11 is basically applied when calibration data is newly generated. As described above, the fluorescent color material chart in which the additional color material is added to the fluorescent color material is generated to prevent an occurrence of a color measurement error; however, once the fluorescent color material chart is generated, it is preferable to use the same fluorescent color material chart when the calibration data is updated. If the additional color material or the additional color material amount is changed depending on situations when the calibration data is updated, characteristics of color measurement values are also changed, so that it becomes difficult to achieve the intended purpose of the calibration, i.e., to stabilize colors. Therefore, after the fluorescent color material chart is generated at the time of newly generating calibration data, the same fluorescent color material chart is continuously used to generate calibration data. With this configuration, the same fluorescent color material chart is continuously used at the time of newly generating calibration data and at the time of updating the calibration data, so that it is possible to achieve the intended purpose of the calibration, i.e., to stabilize colors.

### Step S11

When the fluorescent color material chart is to be newly generated (YES at Step S11), the process goes to Step S12. When the fluorescent color material chart is already generated (NO at Step S11), the process goes to Step S27.

### Step S12

When the fluorescent color material chart is to be newly generated, the calibration unit 104 notifies the additional color material type determination unit 105a of the type of the fluorescent color material to be used for the calibration. Then, the process goes to Step S13.

### Step S13

The additional color material type determination unit 105a determines the type of the additional color material to be added to the fluorescent color material of each of the patches of the fluorescent color material chart on the basis of the type of the fluorescent color material notified by the calibration unit 104. Then, the additional color material type determination unit 105a notifies the additional color material amount determination unit 105b of the determined type of the additional color material and the type of the fluorescent color material. Then, the process goes to Step S14.

### Step S14

The additional color material amount determination unit 105b determines the additional color material amount designated by the additional color material amount designation unit 105c as an amount for which the additional color material of the type notified by the additional color material type determination unit 105a is to be added to the fluorescent color material. Then, the additional color material amount determination unit 105b notifies the chart Generation unit 105d of the type of the fluorescent color material, the type of the additional color material, and the determined additional color material amount. Then, the process proceeds to Step S15.

### Step S15

The chart generation unit 105d generates the fluorescent color material chart on the basis of the type of the fluorescent color material, the type of the additional color material, and the additional color material amount notified by the additional color material amount determination unit 105b. The generated fluorescent color material chart is used to update the calibration data (tone correction table). The chart generation unit 105d stores the generated fluorescent color material chart in the auxiliary storage device 204, sends the fluorescent color material chart to the image conversion unit 101 for printing out the fluorescent color material chart, and sends the fluorescent color material chart to the calibration unit 104 for use for the calibration. Then, the process goes to Step S16.

### Step S16

The fluorescent color material chart that is sent to the image conversion unit 101 is subjected to the processes performed by the tone processing unit 102 and the halftone processing unit 103, and printed out by the image forming apparatus 20 (image formation). Then, the process proceeds to Step S17.

### Step S17

The reading apparatus 40 performs the reading process (color measurement) on the fluorescent color material chart that is printed by the image forming apparatus 20. Then, the process goes to Step S18.

### Step S18

In the reading process performed by the reading apparatus 40, if the color measurement data is not normally obtained, but a color measurement error occurs (YES at Step S18), the process goes to Step S21, and if the color measurement error does not occur (NO at Step S18), the process goes to Step S19.

### Step S19

If the reading apparatus 40 normally obtains the color measurement data, the reading apparatus 40 transmits the color measurement data to the calibration unit 104 via the communication unit 106. Then, the process proceeds to Step S20.

### Step S20

The calibration unit 104 generates, as the calibration. data, the tone correction table that is used for performing tone correction on the image data by the tone processing unit 102, on the basis of the color measurement data received from the reading apparatus 40 and data of the fluorescent color material chart. The calibration unit 104 stores the generated tone correction table in the auxiliary storage device 204, and sends the tone correction table to the tone processing unit 102. The tone processing unit 102 subsequently performs the tone correction process on the image data subjected to the image conversion process by the image conversion unit 101, the total amount control process of controlling the total amount of the color material, and the like by using the tone correction table. Then, the process of generating the calibration data is terminated.

Step S21

In the reading process performed by the reading apparatus 40, the color measurement data is not normally obtained, but a color measurement error occurs, the reading apparatus 40 notifies the reprinting determination unit. 105e of the color measurement error information via the communication unit 106. When receiving the color measurement error information from the reading apparatus 40 via the communication unit 106, the reprinting determination unit 105e determines whether the number of occurrences of a color measurement error reaches the repetition number designated by the repetition number designation unit 105f. Then, the process proceeds to Step S22.

### Step S22

If the number of occurrences of a color measurement error reaches the repetition number (YES at Step S22), the process goes to Step S23, and if the number of occurrences does not reach the repetition number (NO at Step S22), the process goes to Step S25.

### Step S23

If the number of occurrences of a color measurement error reaches the repetition number, the reprinting determination. unit 105e notifies the calibration unit 104 of the calibration impossible notice indicating that the calibration is impossible. Then, the process goes to Step S24.

### Step S24

It is determined that generation of the calibration data (tone correction table) is impossible, and the calibration (process of generating calibration data) is terminated. Meanwhile, instead of Steps S23 and S24, the calibration unit 104 may switch to a mode in which color measurement is performed on the patches of the fluorescent color material chart one by one. In this case, recognition of separators between the patches does not fail and a color measurement error does not occur, so that the color measurement is successful without exception.

### Step S25

If the number of occurrences of a color measurement error does not reach the repetition number, the reprinting determination unit 105e instructs the additional color material amount determination unit 105b to reprint the fluorescent color material chart. Then, the process proceeds to Step S26.

### Step S26

When receiving the instruction on reprinting from the reprinting determination unit 105e, the additional color material amount determination unit 105b determines, as a new additional color material amount, an amount that is obtained by increasing the additional color material amount notified to the chart generation unit 105d by a predetermined amount, and notifies the chart generation unit 105d of the type of the fluorescent color material, the type of the additional color material, and the newly determined additional color material amount. Then, the chart generation unit 105d generates the fluorescent color material chart on the basis of the type of the fluorescent color material, the type of ole additional color material, and the additional color material amount that is newly determined by the additional color material amount determination unit 105b. Then, the process goes to Step S16.

### Step S27

The calibration unit 104 performs the calibration by using the fluorescent color material chart that is already generated and stored. If a color measurement error occurs at the time of updating the calibration data, it is likely that the color measurement error occurs due to an error at ole time of reading or due to output characteristics at the time of printing the fluorescent color material chart; therefore, color measurement may be performed again on the fluorescent color material chart for which the color measurement error has occurred or the same fluorescent color material chart may be reprinted and color measurement may be performed again, instead of increasing the additional color material amount. Then, the process of generating the calibration data is terminated.

As described above, in the image forming system 1 according to the present embodiment, the additional color material type determination unit 105a determines a type of an additional color material to be added to a fluorescent color material that is used to generate a fluorescent color material chart as a color chart, and the chart generation unit 105d generates the fluorescent color material chart in which a plurality of patches, each including the additional color material that is of the type determined by the additional color material type determination unit 105a and that is added to the fluorescent color material, are arranged in a single line and at least a bar of a color of the recording medium P is arranged as a separator between the patches. With this configuration, when color measurement is performed on the fluorescent color material chart in units of one line, it is possible to prevent a failure in recognition of the separator between the patches.

Meanwhile, in the embodiment as described above, if at least any of the functional units of the OFF 10 is implemented by execution of a program, the program is provided by being incorporated in a ROM or the like in advance. Furthermore, the program executed by the DFE 10 according to the embodiment as described above may be provided by being recorded in a computer readable recording medium, such as a compact disc read only memory (CD-ROM), a flexible disk (FD), compact disc-recordable (CD-R), or a digital versatile disk (DVD), in a computer-installable or computer-executable file format. Moreover, the program. executed by the DFE 10 according to the embodiment as described above may be stored in a computer connected to a network, such as the Internet, and provided by being downloaded via the network. Furthermore, the program executed by the DFE 10 according to the embodiment as described above may be provided or distributed via a network, such as the Internet. Moreover, the program executed by the DFE 10 according to the embodiment as described above has a module structure including at least any of the functional units as described above. As actual hardware, the CPU reads the program from the storage device as described above and executes the program, so that each of the functional units as described above is loaded and generated on a main storage device.

Furthermore, each of the functions of the embodiment as described above may be implemented by a single or a plurality of processing circuitries. Here, the “processing circuitry” includes a processor that is programmed to implement each of the functions by software, such as a processor that is implemented by an electronic circuit, and a device, such as an ASIC, a digital signal processor (DSP), an FPGA, or a conventional circuit module, that is designed to implement each of the functions as described above.

According to an embodiment, when color measurement is performed on a fluorescent color material chart in units of one line, it is possible to prevent a failure in recognition of a separator between the patches.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one or the above-described and other methods of the present invention may be implemented by an application specific integrated circuit (ASIC), digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus configured to generate a color chart used for calibration, the information processing apparatus comprising:
a first determination unit configured to determine a type of an additional color material to be added to a fluorescent color material used to generate a fluorescent color material chart as the color chart; and
a generation unit configured to generate the fluorescent color material chart in which a plurality of patches in which the additional color material of the type determined by the first determination unit is added to the fluorescent color material, are arranged in a line and at least a bar of a color of a recording medium is arranged as a separator between the plurality of patches.

2. The information processing apparatus according to claim 1, further comprising:
an acquisition unit configured to acquire color measurement data of each of the plurality of patches, the color measurement data being obtained by performing color measurement in units of one line through a reading process performed by a reading apparatus with respect to the fluorescent color material chart printed by an image forming apparatus;
a calibration unit configured to generate tone correction information for correcting a tone of image data, using the fluorescent color material chart and the color measurement data acquired by the acquisition unit; and
a tone processing unit configured to correct the tone of the image data by using the tone correction information.

3. The information processing apparatus according to claim 1, wherein the first determination unit is configured to determine the type of the additional color material in accordance with a type of the fluorescent color material.

4. The information processing apparatus according to claim 1, further comprising:
a second determination unit is configured to increase an amount of the additional color material to be added to the fluorescent color material, in response to a color measurement error occurring in a reading process performed by a reading apparatus with respect to the fluorescent color material chart printed by an image forming apparatus, wherein
the generation unit is configured to add the increased amount of the additional color material to the fluorescent color material to generate the fluorescent color material chart, the increased amount being increased by the second determination unit.

5. The information processing apparatus according to claim 4, wherein the second determination unit is configured to increase the amount of the additional color material by a constant amount in response to the color measurement error occurring in the reading process.

6. The information processing apparatus according to claim 4, wherein the second determination unit is configured to increase the amount of the additional color material at a constant rate in response to the color measurement error occurring in the reading process.

7. The information processing apparatus according to claim 4, further comprising:
a determination unit configured to determine whether a number of occurrences of the color measurement error reaches a predetermined number in response to the color measurement error occurring in the reading process, wherein
the second determination unit is configured to increase the amount of the additional color material to be added to the fluorescent color material in response to the determination unit determining that the number of occurrences does not reach the predetermined number, and the generation unit is configure to add the increased amount of the additional color material to the fluorescent color material to generate the fluorescent color material chart, the increased amount being increased by the second determination unit.

8. The information processing apparatus according to claim 7, wherein the determination unit is configured to determine that the calibration is not to be performed in response to determining that the number of occurrences reaches the predetermined number.

9. A method of generating a color chart used for calibration, the method comprising:
determining a type of an additional color material to be added to a fluorescent color material used to generate a fluorescent color material chart as the color chart; and
generating the fluorescent color material chart in which a plurality of patches in which the additional color material of the type determined by the first determination unit is added to the fluorescent color material, are arranged in a line and at least a bar with a color of a recording medium is arranged as a separator between the plurality of patches.

10. A non-transitory computer readable medium including programmed. instructions that causes a computer to execute:
determining a type of an additional color material to be added to a fluorescent color material that is used to generate a fluorescent color material chart as the color chart; and
generating the fluorescent color material chart in which a plurality of patches in which the additional color material of the type determined by the first determination unit is added to the fluorescent color material, are arranged in a line and at least a bar with a color of a recording medium is arranged as a separator between the plurality of patches.
